(19) United States
(12) Patent Application Publication
(10) Pub. No.: US 2011/0214106 A1
(43) Pub. Date: Sep. 1, 2011

(54) INDICATING THE EFFECT OF PROGRAM MODIFICATIONS ON PROGRAM PERFORMANCE IN AN INTEGRATED DEVELOPMENT ENVIRONMENT

(75) Inventors: Yao Qi, Beijing (CN); Wei Ying Yu, Beijing (CN); Yong Zheng, Beijing (CN)

(73) Assignee: INTERNATIONAL BUSINESS MACHINES CORPORATION, Armonk, NY (US)

(21) Appl. No.: 13/024,493

(22) Filed: Feb. 10, 2011

(30) Foreign Application Priority Data
Feb. 26, 2010 (CN) 20100117730.1

(51) Int. Cl. G06F 9/44

(52) U.S. Cl. 717/124

(57) ABSTRACT

A method, computer program product and apparatus for indicating program modifications affecting program performance in an Integrated Development Environment (IDE). The modifications that a developer makes to a program is detected and the code location where these modifications occur is determined. The previous profiling data of the program is acquired. The effect of the modifications on the program performance according to the previous profiling data and the code location where the modifications occur is evaluated. The evaluation results may then be provided to the developer. As a result of the above process, the developer can be aware of the performance problem while he/she is editing the source code so as to make corrections without waiting after the profiling phase, thus greatly shortening the development period.

### CROSS-REFERENCE TO RELATED APPLICATIONS

This application claims priority under 35 U.S.C. §119(a) from Chinese Patent Application No. 201010117730.1, filed on Feb. 26, 2010, the contents of which are incorporated herein by reference.

### TECHNICAL FIELD

The present invention relates to the field of computers, particularly to the Integrated Development Environment (IDE), and more particularly, to indicating to developers the effect of program modifications on program performance in an IDE.

### BACKGROUND

Software development is usually carried out in an IDE. The traditional software development cycle includes editing source code, building, testing and profiling. Performance problems, such as performance bottlenecks, may be discovered by profiling. To address the discovered performance problems, a developer edits the source code, builds, tests and profiles the program over again. FIG. 1 illustrates a schematic structure diagram of an IDE 100. Referring to FIG. 1, as shown, IDE 100 includes an editing module 101, a building module 102, a testing module 103, a profiling module 104 and a graphic user interface 105, where the developer may edit, build, test and profile the program with the above modules, and during this process, generate and store building results 106, testing results 107 and profiling data 108.

FIG. 2 illustrates a traditional software development cycle. Referring to FIG. 2, the traditional software development cycle includes editing 201, building 202, testing 203 and profiling 204 which sequentially form a complete cycle. Performance bottlenecks may be found during the profiling phase and editing may be entered again, so that the next cycle begins.

In the above performance problem solving manner, the performance problems introduced in the editing phase will be discovered in the profiling phase and solved by editing the source code in the next cycle. The problem with this solving process is that it is long, since testing and profiling will generally run for a period of time. Furthermore, this process may result in the performance regression problem, i.e., new performance problems may be introduced when the developer is modifying the source code, and the developer is usually unaware of the performance problems caused by his/her modifications. This is because programs are usually complicated, and it is difficult for the developer to evaluate the overall performance effect of the code modifications. In addition, in a collaborative development, a developer only knows about the modules for which he/she is responsible, and has no idea about the modules for which other developers are responsible; more importantly, development is usually separated from testing and profiling. Even though some IDEs comprise an integrated profiler, the developer still needs to wait for a period of time to get the profiling results, then to check the positions where performance bottlenecks and performance regressions are generated, and to try to solve the problems. Such a process for solving performance problems is obviously inefficient.

### BRIEF SUMMARY

In one embodiment of the present invention, a method for indicating program modifications affecting program performance in an Integrated Development Environment comprises detecting modifications that a developer makes to a program. The method further comprises determining a code location where the modifications are made. Additionally, the method comprises acquiring previous profiling data of the program. Furthermore, the method comprises evaluating an effect of the modifications on program performance according to the previous profiling data and the code location where the modifications are made. In addition, the method comprises providing results of the evaluation to the developer.

Other forms of the embodiment of the method described above are in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 is a schematic structure diagram of an Integrated Development Environment (IDE);

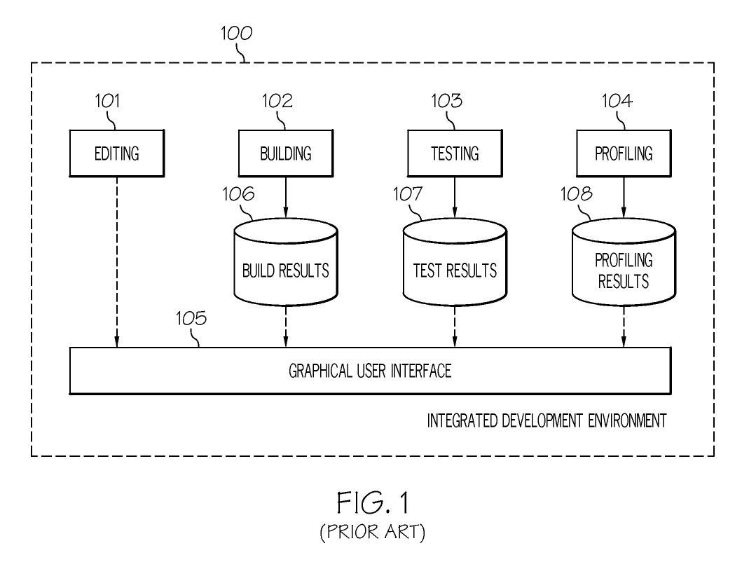

FIG. 2 illustrates a traditional software development cycle;

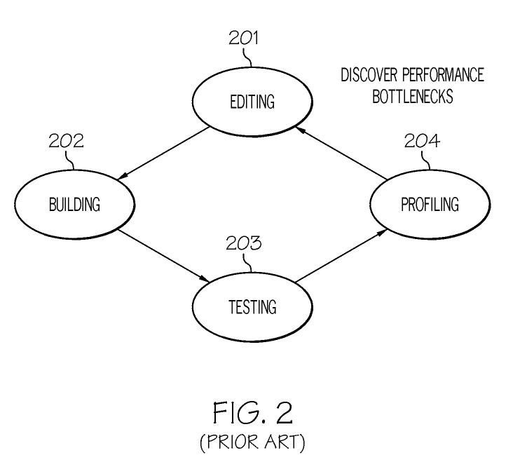

FIG. 3 is a flowchart of a method for indicating program modifications affecting program performance in an IDE according to an embodiment of the present invention;

FIG. 4 is a flowchart of the sub-steps of evaluating the effect of modifications on program performance according to previous profiling data and the code location where the modifications occur according to an embodiment of the present invention;

FIG. 5 is a flowchart of the sub-steps of evaluating the variation of the performance relevant index (i.e., variation of the number of machine instructions) of the function where the modification is located, caused by the modified code according to an embodiment of the present invention;

FIG. 6 is a flowchart of the sub-steps of evaluating the variation of the performance relevant index (i.e., variation of the number of machine instruction clock cycles) of the function where the modification is located, caused by the modified code according to another embodiment of the present invention;

FIG. 7 depicts an embodiment of a hardware configuration of a computer system which is representative of a hardware environment for practicing the present invention; and

FIG. 8 illustrates the software components used for indicating program modifications affecting program performance in an IDE according to an embodiment of the present invention.

### DETAILED DESCRIPTION

The present invention comprises a method, computer program product and apparatus for analyzing previous profiling data of a program, and for indicating to developers the performance loss that may be caused by their modifications while they are modifying the program.

The embodiments of the present invention will now be described with reference to the accompanying drawings. In the following description, numerous details are described to enable the present invention to be fully understood. However, it is obvious to those skilled in the art that the realization of the present invention can be without some of these details. In addition, it should be appreciated that the present invention is not limited to the described specific embodiments. In contrast, it is contemplated to implement the present invention by using any combination of the following features and elements, no matter whether they involve different embodiments or not. Therefore, the following aspects, features, embodiments and advantages are illustrative, rather than elements or limitations of the appended claims, unless explicitly stated otherwise in the claims.

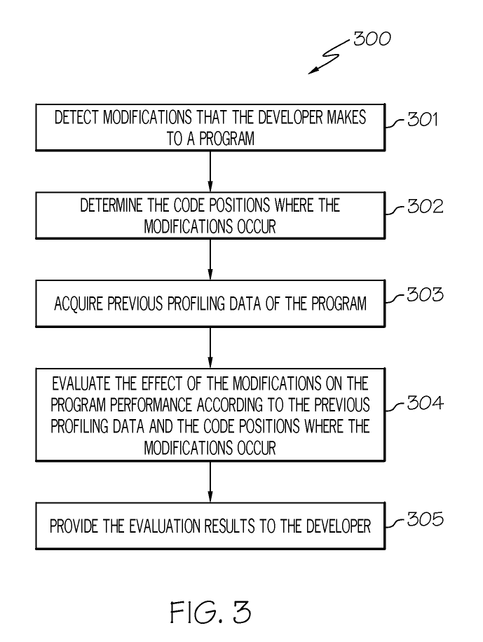

Now referring to FIG. 3, FIG. 3 illustrates a method 300 for indicating program modifications affecting program performance in an Integrated Development Environment (IDE) according to an embodiment of the present invention.

Referring to FIG. 3, in step 301, the modifications that the developer makes to the program in an IDE is detected.

In step 302, the code locations where the modifications occur are determined. According to an embodiment of the present invention, step 302 includes determining the function where the modified code is located. In one embodiment, step 302 assumes that all the modifications to the program are performed inside existing functions of the program. As for changes outside the existing functions (e.g., adding a new function outside the existing functions), there are callings of the newly added function being added in some existing function, and thus this step will determine the function calling the newly added function, and will not determine the newly added function itself. In programming languages, such as the C programming language, a macro may be defined, and the macro may be invoked by a function. Modifying an existing macro or adding a new macro will also result in performance variation of the function calling the macro. Therefore, determining the function in which the modified code is located also includes determining all the functions invoking a modified macro or a newly added macro.

It should be noted that the term “function” used herein refers to any relatively independent code segment that accomplishes a specific function in the program, including subroutines, methods, procedures, sub-programs, etc. in different programming languages.

In step 303, the previous profiling data of the program is obtained. Profiling data is generated during the profiling phase of the program, and it includes various performance data and performance relevant data in a number of previous program executions, such as performance indexes (e.g., a statistic value of the number of processor clock cycles consumed by the functions during a number of program runnings), performance relevant indexes (e.g., the amount of machine instructions or the amount of machine instruction clock cycles consumed by the functions), and the invocation frequencies of the functions in a number of previous program runnings. The following table illustrates an exemplary structure of the profiling data:

TABLE 1
Exemplary structure of the profiling data

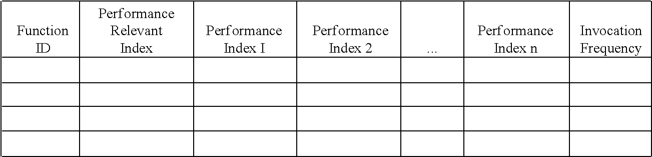

where the Function ID is the identification of a function in the program; performance relevant index refers to the performance relevant factors of the function itself (e.g., the number of static machine instructions, the number of machine instruction clock cycles of the function); performance index 1 . . . performance index n are the actual performance indexes profiled for the corresponding function in a number of previous runnings, such as the total number or average number of the consumed processor clock cycles; and the invocation frequency is the frequency or percentage that the function is invoked during the previous runnings

The above profiling data may be generated directly by the profiling process, or may be extracted from the data generated in the profiling process.

In step 304, the effect of the modifications on the program performance is evaluated according to the previous profiling data and the code location where the modifications occur. According to an embodiment of the present invention, step 304 includes evaluating the expected variation, which is caused by the modifications, of the performance index of the function in which the modifications are located according to the previous profiling data, and evaluating the effect of the modifications on the program performance according to the expected variation of the performance index of the function. Therein, evaluating the expected variation, which is caused by the modifications, of the performance index of the function in which the modifications are located according to the previous profiling data includes: evaluating the variation, which is caused by the modifications, of the performance relevant index of the function in which the modifications are located; and evaluating the expected variation, which is caused by the modifications, of the performance index of the function in which the modifications are located according to the variation of the performance relevant index. And therein, evaluating the effect of the modifications on the program performance according to the expected variation of the performance index of the function includes: evaluating the effect of the modifications on the program performance according to the ratio of the expected variation of the performance index of the function to the sum of the performance indexes of all the functions of the program, as well as the frequency that the function is invoked during the program running

In step 305, the evaluation results are provided to the developer.

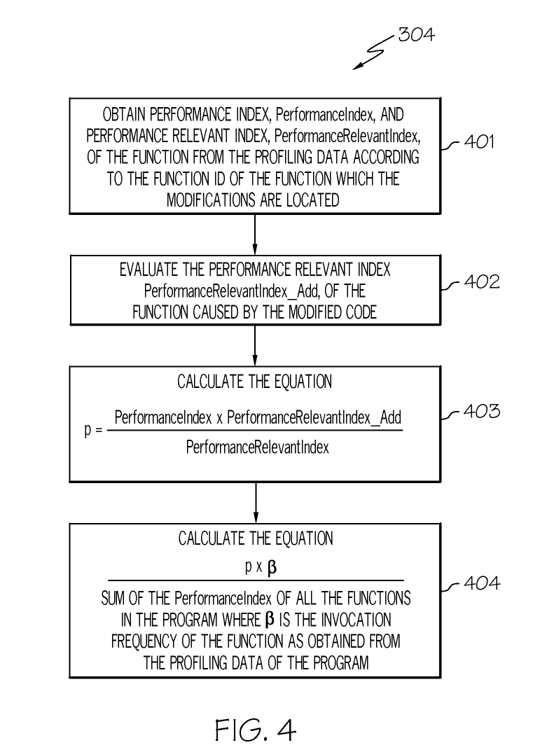

FIG. 4 is a flowchart of the sub-steps of step 304 for evaluating the effect of the modifications on the program performance according to the previous profiling data and the code location where the modifications occur according to an embodiment of the present invention.

Referring to FIG. 4, in conjunction with FIG. 3, in step 401, the performance index, PerformanceIndex, and performance relevant index, PerformanceRelevantIndex, of the function are obtained from the profiling data according to the function ID of the function in which the modifications are located as determined in step 302. The performance index, PerformanceIndex, may be a statistic value of the number of processor clock cycles consumed by the function in a number of previous program runnings, such as the sum of the number of processor clock cycles or the average value in each running The performance relevant index may be either the number of machine instructions consumed by the function, or the number of machine instruction clock cycles consumed by the function.

In step 402, the variation amount of the performance relevant index, PerformanceRelevantIndex_Add, of the function caused by the modified code is evaluated.

In step 403, the following equation (EQ1) is calculated:

$$p = \frac{PerformanceIndex \times PerformanceRelevantIndex\_Add}{PerformanceRelevantIndex} \qquad ( EQ 1 )$$

where PerformanceIndex and PerformanceRelevantIndex are the performance index and performance relevant index of the function in which the modifications are located that are obtained in step 401, respectively. p denotes the expected variation of the performance index of the function in which the modifications are located, caused by the modifications, as evaluated according to the variation of the performance relevant index of the function in which the modifications are located, caused by the modifications.

In step 404, the variable α is calculated using the following equation (EQ2):

$$α = \frac{p \times β}{ \begin{matrix}the sum of PerformanceIndex \\ of all the functions in the program\end{matrix}} \qquad ( EQ 2 )$$

where p is the expected variation of the performance index in which the modifications are located, as evaluated in step 403; β is the invocation frequency of the function as obtained from the profiling data of the program (e.g., the percentage that the function is invoked in a number of program runnings); α denotes the effect of the modifications on the program's overall performance, and it is evaluated according to the expected variation, which is caused by the modifications, of the performance index of the function in which the modifications are located and in consideration of the ratio of the expected variation of the performance index of the function in the sum of performance indexes of all the functions in the program and the invocation frequency of the function.

According to an embodiment of the present invention, in step 305, the value α, as calculated in step 404, may be presented to the developer, to indicate to him/her the effect of the modifications on the program performance. According to another embodiment of the present invention, the value a may also first be compared with a pre-defined threshold, and when the value α is larger than the threshold, it is indicated to the developer that his/her modifications may greatly affect the program performance. It should be noted that the above steps are performed in the phase that the developer is editing the code in an IDE so that the performance influence probably caused by the editing actions of the developer can be timely indicated. As a result, the developer may carry out performance optimization in time, thus reducing performance regression and enhancing the development efficiency.

According to an embodiment of the present invention, the performance relevant index is the number of machine instructions consumed by the function, and the variation amount of the performance relevant index, PerformanceRelevantIndex_Add, is the variation amount of the machine instructions of the function, named as FIA (Function_Instruction_Add) caused by the code modifications.

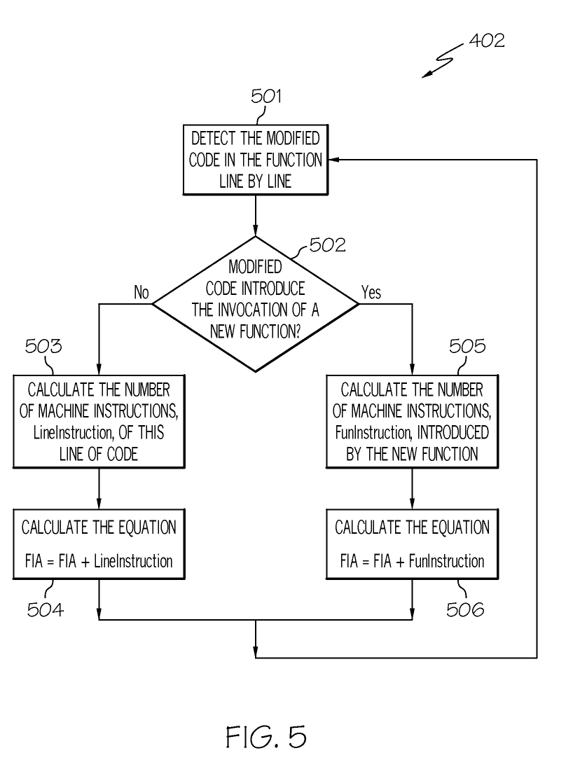

FIG. 5 is a flowchart of the sub-steps of step 402 for evaluating the variation amount of the performance relevant index of the function caused by the modified code according to an embodiment of the present invention.

Referring to FIG. 5, in step 501, the modified code in the function is detected line by line. For the case that a modified or newly added macro is invoked by a function in programming languages, such as C, the code of the modified or newly added macro will be viewed as the code of the function itself, and will be detected line by line.

In step 502, a determination is made as to whether the modified code introduces a new function invocation.

If the modified code does not introduce a new function invocation, then, in step 503, the number of machine instructions of this line of code, LineInstruction, is calculated. As known in the art, the number of machine instructions of a code line may be obtained by compiling the modified program code and then calculating from the compiled binary code.

In step 504, the equation FIA=FIA+LineInstruction is calculated, assuming that the initial value of FIA is 0. Upon executing step 504, the modified code in the function is detected line by line in step 501. If the modifications are not simply adding new code lines, but modifying old code lines into new code lines, then the number of machine instructions of the old code lines should be further subtracted from the above expression.

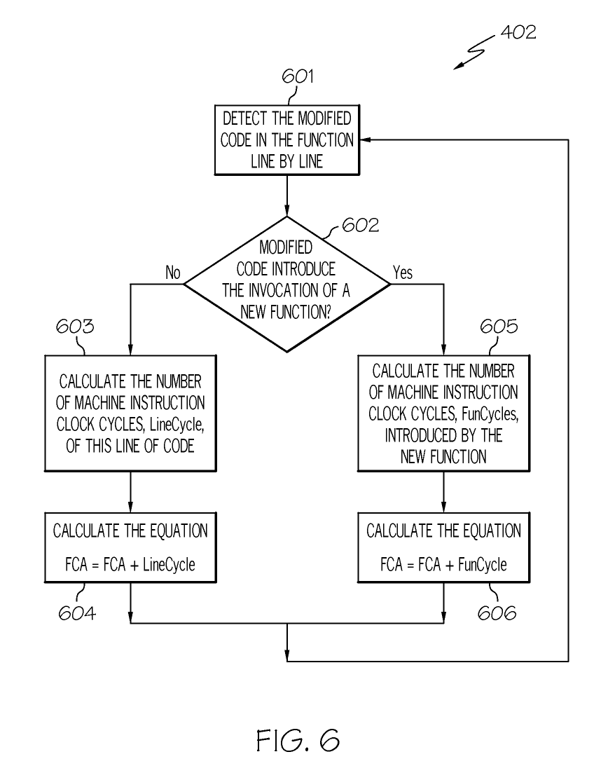

If, however, the modified code introduces a new function invocation, then in step 505, the number of machine instructions introduced by the new function, FunInstruction, is calculated. As known in the art, the number of machine instructions introduced by the new function may be obtained by compiling the modified program code and from the compiled binary code, or may be obtained by accumulating the number of machine instructions of all the instruction lines contained in the new function. For the case where the newly introduced function invocation is an I/O function invocation, since the I/O functions with the same number of instructions may consume substantially different processor clock cycles, it is preferable to use another embodiment illustrated in FIG. 6 and described below to evaluate the variation amount of the performance relevant index of the function caused by the modified code.

In step 506, the equation FIA=FIA+FunInstruction is calculated. Upon executing step 506, the modified code in the function is detected line by line in step 501. If the modifications are not simply adding a new function invocation, but replacing an old function invocation by a new function invocation, then the number of machine instructions of the old function may be further subtracted from the above expression.

In one embodiment, the above process is performed iteratively, until all the modified code lines in the function have been processed, so as to obtain the final machine instruction variation amount FIA of the function caused by the code modification.

According to another embodiment of the present invention, the performance relevant index is the number of machine instruction clock cycles consumed by the function, and the variation amount of the performance relevant index, PerformanceRelevantIndex_Add, is the variation amount of machine instruction clock cycles FCA (Function_Cycle_Add) of the function caused by the code modifications. FIG. 6 is a flowchart of the sub-steps of step 402 for evaluating the variation amount of the performance relevant index (i.e., the variation amount of machine instruction clock cycles) of the function caused by the modified code according to an embodiment of the present invention.

Referring to FIG. 6, in step 601, the modified code in the function is detected line by line. For the case that a modified or newly added macro is invoked by a function in a programming language, such as C, the code in the modified or newly added macro will be viewed as the code of the function itself, and is detected line by line.

In step 602, a determination is made as to whether the modified code introduces a new function invocation.

If the modified code does not introduce a new function invocation, then, in step 603, the number of machine instruction clock cycles, LineCycle, of this line of code is calculated. As known in the art, the number of machine instruction clock cycles of a code line may be calculated by the number of machine instructions of the code line and the clock cycles occupied by each machine instruction.

In step 604, the equation FCA=FCA+LineCycle is calculated, assuming that the initial value of FCA is 0. Upon executing step 604, the modified code in the function is detected line by line in step 601. If the modifications are not only simply adding new code lines, but modifying old code lines into new code lines, then the number of machine instruction clock cycles of the old code lines should be further subtracted from the above expression.

If, however, the modified code introduces a new function invocation, then in step 605, the number of machine instruction clock cycles, FunCycle, introduced by the new function is calculated. As known in the art, the number of machine instruction clock cycles introduced by the new function may be obtained by accumulating the number of machine instruction clock cycles of all the instruction lines contained in the new function. For the case where the newly introduced function invocation is an I/O function invocation, since the number of processor clock cycles consumed by I/O functions with the same number of machine instructions may differ greatly, and since I/O functions are usually included in third-party library functions, the number of clock cycles consumed by the I/O functions needs to be recorded in the third-party library functions (which is evaluated by the third-party). Thus, when the I/O function is introduced for the first time due to program modifications, the number of clock cycles may be obtained from the third-party library function as the number of machine instruction clock cycles introduced by this new I/O function. In future profiling, performance data of the I/O function (i.e., the number of clock cycles) may be further collected to replace the number of clock cycles provided by the third party for evaluating the variation amount of the performance relevant index.

In step 606, the equation FCA=FCA+FunCycle is calculated. Upon executing step 606, the modified code in the function is detected line by line in step 601. If the modifications are not simply adding a new function invocation, but modifying an old function invocation into a new function invocation, then the number of machine instruction clock cycles of the old function should be further subtracted from the above expression.

In one embodiment, the above process is performed iteratively, until all the modified code lines in the function are processed, so as to obtain the final machine instruction variation amount FCA of the function caused by the code modifications.

Above is described a method for indicating program modifications affecting program performance in an IDE according to the embodiments of the present invention. It should be pointed out that the above description and illustration are exemplary. In other embodiments of the present invention, the method may have more, less or different steps, and the details of the respective steps and the order among the steps may be different from that is illustrated and described. For example, according to one embodiment of the present invention, in step 304, the invocation frequency of the function in which modifications are located may further be determined; and if the invocation frequency is too small, e.g., smaller than 0.1, then it may be determined that the modifications to this function will not cause significant effect on the program performance, so that the evaluation for this function may be omitted. For further example, while the above description uses the number of processor clock cycles as the performance index of the function, and uses the number of machine instructions and the number of machine instruction clock cycles as the performance relevant index of the function; this is exemplary; and in some other embodiments of the present invention, other performance indexes and performance relevant indexes may be used. Furthermore, the above described method for calculating the performance relevant index of the function and the formula in steps 403 and 404 are exemplary as well, and they may have other variations in other embodiments of the present invention.

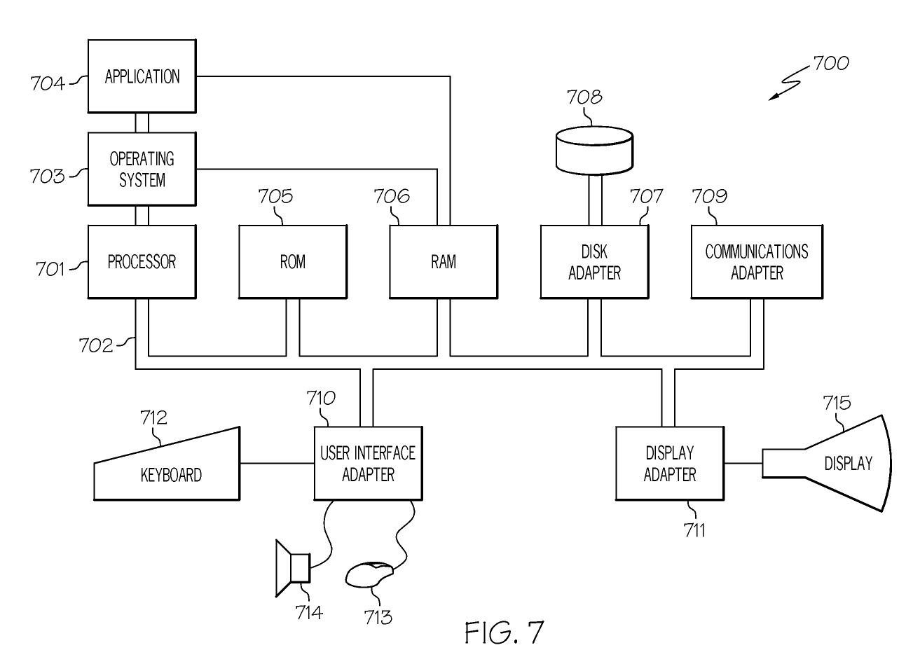

FIG. 7 depicts an embodiment of a hardware configuration of a computer system 700 which is representative of a hardware environment for practicing the present invention. Referring to FIG. 7, computer system 700 has a processor 701 coupled to various other components by system bus 702. An operating system 703 may run on processor 701 and provide control and coordinate the functions of the various components of FIG. 7. An application 704 in accordance with the principles of the present invention may run in conjunction with operating system 703 and provide calls to operating system 703 where the calls implement the various functions or services to be performed by application 704. Application 704 may include, for example, an application for indicating to developers the effect of program modifications on program performance in an IDE as discussed above.

Referring again to FIG. 7, read-only memory (“ROM”) 705 may be coupled to system bus 702 and include a basic input/output system (“BIOS”) that controls certain basic functions of computer device 700. Random access memory (“RAM”) 706 and disk adapter 707 may also be coupled to system bus 702. It should be noted that software components including operating system 703 and application 704 may be loaded into RAM 706, which may be computer system's 700 main memory for execution. Disk adapter 707 may be an integrated drive electronics (“IDE”) adapter that communicates with a disk unit 708, e.g., disk drive.

Computer system 700 may further include a communications adapter 709 coupled to bus 702. Communications adapter 709 may interconnect bus 702 with an outside network (not shown) thereby allowing computer system 700 to communicate with other similar devices.

I/O devices may also be connected to computer system 700 via a user interface adapter 710 and a display adapter 711. Keyboard 712, mouse 713 and speaker 714 may all be interconnected to bus 702 through user interface adapter 710. Data may be inputted to computer system 700 through any of these devices. A display monitor 715 may be connected to system bus 702 by display adapter 711. In this manner, a user is capable of inputting to computer system 700 through keyboard 712 or mouse 713 and receiving output from computer system 700 via display 715 or speaker 714.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to product a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

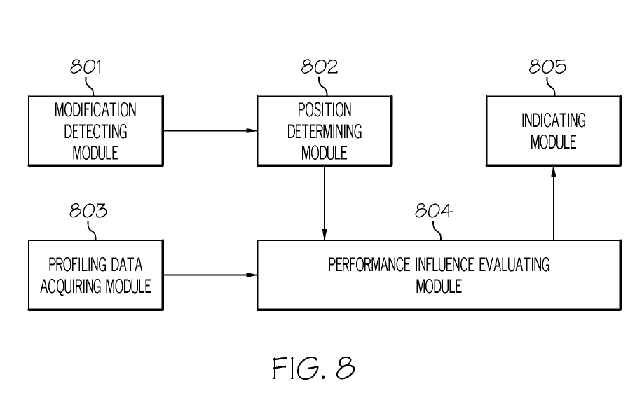

FIG. 8 illustrates the software components used for indicating program modifications affecting program performance in an IDE according to an embodiment of the present invention. In one embodiment, these software components are the components or modules of the program for indicating program modifications affecting program performance in an IDE, where the program may reside in application 704 (FIG. 7).

Now referring to FIG. 8, the software modules include a modification detecting module 801 for detecting modifications to a program made by the developer in an IDE; a position determining module 802 for determining the code location where the modifications are made; a profiling data acquiring module 803 for acquiring previous profiling data; a performance influence evaluating module 804 for evaluating the influence or effect of the modifications on the program performance according to the previous profiling data and the code location where modifications are made; and an indicating module 805 for indicating the evaluation results to the developer.

According to an embodiment of the present invention, determining the code location where the modifications occur comprises determining the function in which the modifications are located, and the previous profiling data comprises the performance index of the function in the program in the previous program running.

According to an embodiment of the present invention, the performance influence evaluating module 804 is used for: evaluating the expected variation, which is caused by the modifications, of the performance index of the function in which the modifications are located according to the previous profiling data, and evaluating the effect of the modifications on the program performance according to the expected variation of the performance index of the function.

According to an embodiment of the present invention, evaluating the expected variation, which is caused by the modifications, of the performance index of the function in which the modifications are located according to the previous profiling data comprises: evaluating the variation, which is caused by the modifications, of the performance relevant index of the function in which the modifications are located; and evaluating the expected variation, which is caused by the modifications, of the performance index of the function in which the modifications are located according to the variation of the performance relevant index.

According to an embodiment of the present invention, evaluating the effect of the modifications on the program performance according to the expected variation of the performance index of the function comprises: evaluating the effect of the modifications on the program performance according to the ratio of the expected variation of the performance index of the function to the sum of the performance indexes of all functions of the program and the invocation frequency of the function in the program running

According to an embodiment of the present invention, the performance index is a statistic value of the processor clock cycles consumed by the function in previous program running

According to an embodiment of the present invention, the performance relevant index is the number of machine instructions of the function. According to another embodiment of the present invention, the performance relevant index is the number of machine instruction clock cycles of the function.

Above is described the apparatus for indicating program modifications affecting program performance in an IDE according to the embodiments of the present invention. It should be pointed out that the above description and illustration are exemplary. In other embodiments of the present invention, the apparatus may have more, less or different modules, and the relationships, such as connection and inclusion relationships, among the modules may be different from that is described. The modules discussed above may be inside an IDE as a module of the IDE, or may be a standalone module outside the IDE and work together with IDE.

The following describes the working process of the method of the present invention by way of an example using the following exemplary program:

| | |
|---|---|
| 1 | #include <stdio.h> |
| 2 | extern int |
| 3 | init_args(int argc, char *argv[ ]) |
| 4 | { |
| 5 | //initiate the args |
| 6 | } |
| 7 | |
| 8 | extern int |
| 9 | search_entry(int *list, int id) |
| 10 | { |
| 11 | //find the ID in the list |
| 12 | } |
| 13 | |
| 14 | extern int |
| 15 | main(int argc, char *argv[ ]) |
| 16 | { |
| 17 | int data[100] = {0}; |
| 18 | int ret, id = −1; |
| 19 | |
| 20 | id = init_args(argc, argv); |
| 21 | |
| 22 | ret = search_entry(data, id); |
| 23 | |
| 24 | cleaup( ); |
| 25 | } |

Assuming the processor clock cycles is selected as the performance index for profiling, and the number of machine instructions is selected as the performance relevant index, the profiling data are shown in the following table:

TABLE 2

| | Number of Machine | Processor |
|---|---|---|
| Function ID | Instructions | Clock Cycles |
| Main | 200 | 2400 |
| init_args | 500 | 4000 |
| search_entry | 900 | 6700 |

It is assumed that the developer modifies the above example program as follows:

| | |
|---|---|
| 1 | #include <stdio.h> |
| 2 | |
| 3 | extern int |
| 4 | init_args(int argc, char *argv[ ]) |
| 5 | { |
| 6 | //initiate the args |
| 7 | } |
| 8 | |
| 9 | extern int |
| 10 | search_entry(int *list, int id) |
| 11 | { |
| 12 | //find the ID in the list |
| 13 | } |
| 14 | |
| 15 | extern int |
| 16 | sort_data(char *list) |
| 17 | { |
| 18 | //sort the list |
| 19 | } |
| 20 | |
| 21 | extern int |
| 22 | main(int argc, char *argv[ ]) |
| 23 | { |
| 24 | int data[100] = {0}; |
| 25 | int ret, id = −1; |
| 26 | |
| 27 | id = init_args(argc, argv); |
| 28 | |
| 29 | printf(“Will sort the list first...\n”); |
| 30 | ret = sort_data(data); |
| 31 | |
| 32 | ret = search_entry(data, id); |
| 33 | |
| 34 | if (ret > 0) |
| 35 | printf(“succeed to find the ID!\n”); |
| 36 | } |

In the above modified program, lines 15-19 are a newly added function, sort_data ( ), and lines 29-30 are the newly added code. According to the process illustrated in FIGS. 3, 4 and 5 and described above, it is detected in step 301 that the developer has modified the program, and in step 302 it is determined that the location in which code is modified is the function “main”; in step 303, the previous profiling data of the program is acquired (i.e., Table 2). Next, in step 401, the number of machine instructions (i.e., PerformanceRelevantIndex) of the main function acquired from Table 2 is 200 and the number of processor clock cycles (i.e., PerformanceIndex) is 2400. In step 503, it is calculated that the newly added code at line 29 has 8 machine instructions, while in step 504, it is calculated that the new function sort_data( ) invoked at line 30 has 420 instructions. Thus, in step 402, the variation amount of the performance relevant index (i.e., the variation amount of the machine instructions) of the main function, PerformanceRelevantIndex_Add, is obtained (equals 8+420=428 machine instructions). Since function main ( ) is the entry point of the program, the percentage that it is invoked is β=100%, i.e., function main ( ) will always be invoked. Thus, in step 403, the following is calculated.

$$\begin{matrix}p = \frac{PerformanceIndex \times PerformanceRelevantIndex\_Add}{PerformanceRelevantIndex} \\ = \frac{2400 \times 428}{200} \\ = 5136\end{matrix}$$

This means that the newly added 428 machine instructions in main ( ) will consume 5136 processor clock cycles. Then, in step 404, the following is calculated.

$$\begin{matrix}α = \frac{p \times β}{ \begin{matrix}the sum of PerformanceIndex \\ of all the functions in the program\end{matrix}} \\ = \frac{5136 \times 100 \%}{2400 + 4000 + 6700} \approx 39 \%\end{matrix}$$

That is, the newly added code will result in a performance loss of 39% of the original program. Assuming the predetermined threshold is 10%, since 39%>10%, it is indicated to the developer.

Although the present invention has been illustrated and described with reference to the preferred embodiments, those skilled in the art will understand that various changes both in form and details may be made thereto without departing from the spirit and scope of the present invention.

1. A method for indicating program modifications affecting program performance in an Integrated Development Environment, the method comprising:
detecting modifications that a developer makes to a program;
determining a code location where the modifications are made;
acquiring previous profiling data of the program;
evaluating an effect of the modifications on program performance according to the previous profiling data and the code location where the modifications are made; and
providing, by a processor, results of the evaluation to the developer.

2. The method of claim 1, wherein said determining the code location where the modifications are made comprises determining a function in which the modifications are located, and the previous profiling data at least comprises performance index of the function in which the modifications are located in a previous program running.

3. The method of claim 2, wherein said evaluating the effect of the modifications on the program performance according to the previous profiling data and the code location where the modifications occur comprises:
evaluating an expected variation of the performance index of the function in which the modification are located according to the previous profiling data; and
evaluating the effect of the modifications on the program performance according to the expected variation of the performance index of the function.

4. The method of claim 3, wherein said evaluating the expected variation, caused by the modifications, of the performance index of the function in which the modifications are located according to the previous profiling data comprises:
evaluating a variation, caused by the modifications, of a performance relevant index of the function in which the modifications are located; and
evaluating the expected variation, caused by the modifications, of the performance index of the function in which the modifications are located according to the variation of the performance relevant index.

5. The method of claim 3, wherein said evaluating the effect of the modifications on the program performance according to the expected variation of the performance index of the function comprises:
evaluating the effect of the modifications on the program performance according to a ratio of the expected variation of the performance index of the function to a sum of performance indexes of all functions in the program and an invocation frequency of the function in a program running.

6. The method of claim 2, wherein the performance index is a statistic value of processor clock cycles consumed by the function in the previous program running.

7. The method of claim 4, wherein the performance relevant index is a number of machine instructions.

8. The method of claim 7, wherein said evaluating the variation, caused by the modifications, of the performance relevant index of the function in which the modifications are located further comprises:
determining the modifications in the function; and
calculating variation of the number of machine instructions of a line of code according to the modifications as the variation, caused by the modifications, of the performance relevant index of the function in which the modifications are located.

9. The method of claim 4, wherein the performance relevant index is a number of machine instruction clock cycles.

10. The method of claim 9, wherein said evaluating the variation, caused by the modifications, of the performance relevant index of the function in which the modifications are located further comprises:
determining the modifications in the function; and
calculating variation of the number of machine instruction clock cycles of a line of code according to the modifications, as the variation, caused by the modifications, of the performance relevant index of the function in which the modifications are located.

11. A computer program product embodied in a computer readable storage medium for indicating program modifications affecting program performance in an Integrated Development Environment (IDE), the computer program product comprising the programming instructions for:
detecting modifications that a developer makes to a program;
determining a code location where the modifications are made;
acquiring previous profiling data of the program;
evaluating an effect of the modifications on program performance according to the previous profiling data and the code location where the modifications are made; and
providing results of the evaluation to the developer.

12. The computer program product of claim 11, wherein the programming instructions for determining the code location where the modifications are made comprises the programming instructions for determining a function in which the modifications are located, and the previous profiling data at least comprises performance index of the function in which the modifications are located in previous runnings of the program.

13. The computer program product of claim 12, wherein the programming instructions for evaluating the effect of the modifications on the program performance according to the previous profiling data and the code location where the modifications occur comprises the programming instructions for:
evaluating an expected variation of the performance index of the function in which the modification are located according to the previous profiling data; and
evaluating the effect of the modifications on the program performance according to the expected variation of the performance index of the function.

14. The computer program product of claim 13, wherein the programming instructions for evaluating the expected variation, caused by the modifications, of the performance index of the function in which the modifications are located according to the previous profiling data comprises the programming instructions for:
evaluating a variation, caused by the modifications, of a performance relevant index of the function in which the modifications are located; and
evaluating the expected variation, caused by the modifications, of the performance index of the function in which the modifications are located according to the variation of the performance relevant index.

15. The computer program product of claim 13, wherein the programming instructions for evaluating the effect of the modifications on the program performance according to the expected variation of the performance index of the function comprises the programming instructions for:
evaluating the effect of the modifications on the program performance according to a ratio of the expected variation of the performance index of the function to a sum of performance indexes of all functions in the program and an invocation frequency of the function in a program running.

16. The computer program product of claim 12, wherein the performance index is a statistic value of the processor clock cycles consumed by the function in the previous runnings of the program.

17. The computer program product of claim 14, wherein the performance relevant index is the number of machine instructions.

18. The computer program product of claim 17, wherein the programming instructions for evaluating the variation, caused by the modifications, of the performance relevant index of the function in which the modifications are located further comprises the programming instructions for:
determining the modifications in the function; and
calculating variation of the number of machine instructions of a line of code according to the modifications as the variation, caused by the modifications, of the performance relevant index of the function in which the modifications are located.

19. The computer program product of claim 12, wherein the performance relevant index is a number of machine instruction clock cycles.

20. The computer program product of claim 19, wherein the programming instructions for evaluating the variation, caused by the modifications, of the performance relevant index of the function in which the modifications are located further comprises the programming instructions for:
determining the modifications in the function; and
calculating variation of the number of machine instruction clock cycles of a line of code according to the modifications, as the variation, caused by the modifications, of the performance relevant index of the function in which the modifications are located.
